(19) United States
(12) Patent Application Publication
(10) Pub. No.: US 2015/0251634 A1
(43) Pub. Date: Sep. 10, 2015

(54) WINDSCREEN WIPER DEVICE FOR A VEHICLE

(71) Applicant: ROBERT BOSCH GMBH, Stuttgart (DE)

(72) Inventors: Michael Weiler, Buehl (DE); Florian Hauser, Achern (DE); Kris Van De Rostyne, Opvelp (BE)

(21) Appl. No.: 14/441,254

(22) PCT Filed: Oct. 24, 2013
(86) PCT No.: PCT/EP2013/072282

§ 371 Date: May 7, 2015

(30) Foreign Application Priority Data
Nov. 7, 2012 (DE) 10 2012 220 209.9

(51) Int. Cl. B60S 1/38

(52) U.S. Cl. CPC B60S 1/3801; B60S 1/381

(57) ABSTRACT

The present invention relates to a windscreen wiper device (2; 28, 30; 74; 78) for a vehicle, in particular a motor vehicle. The windscreen wiper device (2; 28, 30; 74; 78) has an elongate upper part (10) which is at least partially of bendable design. Furthermore, said windscreen wiper device contains an elongate lower part (12) which is at least partially of bendable design. Furthermore, there is a plurality of connecting elements (18) for connecting the upper part (10) and the lower part (12), wherein the connecting elements (18) are spaced apart from one another along a longitudinal extent (8) of the windscreen wiper device (2; 28, 30; 74; 78) and are fastened to the lower part (12) by means of rotary joints (20).

### BACKGROUND OF THE INVENTION

The invention relates to a windscreen wiper device for a vehicle, in particular a motor vehicle, having an elongate upper part, an elongate lower part and a plurality of connecting elements spaced apart from one another for connecting the upper part and the lower part.

Windscreen wiper devices typically have a wiper arm or a wiper lever, wherein a wiper blade is moved on the windscreen of a motor vehicle among other things. In this case, the wiper blade is moved between an upper turning position and a lower one. Particularly on windscreens with sharp changes of curvature, the windscreen blade easily loses contact with the windscreen. This can lead to unwiped areas or smearing, particularly in the case of sharply curved windscreens.

Because a wiping action has to be optimized in relation to a plurality of parameters, such as the amount of rain on the windscreen, a possible snow load on the windscreen, the vehicle speed and associated wind pressure on the wiper arm, smearing cannot simply be prevented by adjusting the wiper arm pressure on the windscreen. There is therefore a need for windscreen wipers to be further improved.

### SUMMARY OF THE INVENTION

The problem addressed by the present invention is that of guaranteeing reliable, largely streak-free wiping of a vehicle windscreen.

According to one embodiment of the present invention, a windscreen wiper device is proposed for a vehicle, in particular a motor vehicle. The windscreen wiper device exhibits an elongate upper part which is at least partially of bendable design. In addition, an elongate lower part is present which is at least partially of bendable design. A plurality of connecting elements for connecting the upper part and the lower part are spaced apart from one another along a longitudinal extent of the windscreen wiper device and fastened to the lower part by means of rotary joints.

Preferred embodiments and particular aspects of the invention emerge from the dependent claims, the drawings and the present description.

The present invention and the embodiments thereof advantageously allow the windscreen wiper device to be particularly well adjusted to the curvature of a windscreen. This guarantees particularly good and accurate wiping of the windscreen. Unwiped regions of the windscreen and smearing on the windscreen can be largely avoided. The structural embodiment of the windscreen wiper device according to the invention advantageously allows precise adjustment of the windscreen wiper device to curvature changes occurring within the windscreen. A largely uniform contact pressure on the windscreen wiper device, in particular on its lower part, is also achieved with sharp curvatures and changes in curvature of the windscreen. Compared with traditional windscreen wiper devices, with the windscreen wiper device according to the invention it is advantageously unnecessary to perform a prior adjustment of the upper part and/or the lower part to the curvature of the windscreen being wiped. Adjustment to the curvature of the windscreen takes place quickly, simply and largely independently with the windscreen wiper device according to the invention. For the sake of convenience, one and the same windscreen wiper device can therefore be used for a large number of vehicles.

The windscreen wiper device is advantageously designed such that torsional movements are possible between the connecting elements and the lower part. This guarantees high flexibility and adjustability of the lower part. Furthermore, the connecting elements are likewise fastened to the upper part by means of rotary joints in an advantageous embodiment of the invention. This ensures even better adjustability of the windscreen wiper device to the windscreen to be wiped, wherein a high contact pressure on the windscreen in particular and with it a particularly good cleaning and wiping effect can be achieved. The windscreen wiper device is particularly advantageously designed such that torsional movements are possible between the connecting elements and the upper part. The rotary joints are advantageously hinges. The windscreen wiper device according to the invention is particularly configured such that the upper part and lower part are of beam-like design. Furthermore, it is advantageously possible for the upper part and the lower part to be at least partially flexible. According to one embodiment of the invention, the upper part and lower part are movable in respect of one another. In a further embodiment, the upper part is disposed opposite the lower part. The connecting elements are fastened to insides of the upper and lower part which are facing one another. The connecting elements are particularly advantageously kink-resistant.

According to one embodiment of the invention, the upper part and the lower part, particularly in an end region of the windscreen wiper device, are fixedly connected to one another at an outer connection position. The outer connection position, particularly viewed in a longitudinal extent of the windscreen wiper device in an inward direction from outside, is configured in front of the connecting elements. This embodiment advantageously guarantees particularly good stability of the windscreen wiper device. In addition, a particularly high flexibility and adaptability to the curvature of the windscreen can be achieved, wherein there is a uniform contact pressure of the lower part on the windscreen. In a further advantageous embodiment, the upper part and the lower part may be connected to one another at the outer connection position, such that the upper part and the lower part form a wedge. The upper part and the lower part are particularly connected to one another at their ends. According to further embodiments, one or a plurality of first connecting elements and one or a plurality of second connecting elements are provided as follows. A first connecting element is arranged in comparison with the second connecting element, such that the first connecting element lies relative to the second connecting part in the direction of the connection position of the upper part and the lower part, i.e. in the direction of the tip of the wedge or outside. In this case, the first connecting element is shorter than the second connecting element. For example, at least 70% or at least 50% of the connecting elements may be configured such that they are shorter outwardly, i.e. in the direction of the connection position of the upper part and the lower part.

According to yet further embodiments which can be combined with other embodiments, the lower part is of convex design in the unloaded state, i.e. having an arching which projects away from the upper part in the middle region. On contact with a windscreen, starting from the convex form of the lower part, the windscreen wiper device according to the embodiments described here may typically adopt the corresponding concave form of the lower part which adapts to the windscreen.

According to a further embodiment, the longitudinal axes of the connecting elements run at angles to the lower part of between 65° and 115°, particularly between 75° and 105°. This advantageously guarantees a particularly good transmission of a force acting on the lower part to the upper part. In addition, a particularly stable windscreen wiper device can be achieved in this way. The angles are particularly advantageously between 80° and 100°.

According to a further embodiment, the space between every two adjacent connecting elements is smaller than 50 mm, in particular smaller than 30 mm. This means that a particularly high flexibility of the windscreen wiper device, particularly the lower part thereof, and good adjustment to the curvature and changes in curvature of the windscreen being wiped is guaranteed.

According to a further typical embodiment, the upper part is of one or two-piece design. In this way, high stability of the windscreen wiper device can be achieved.

According to a further advantageous embodiment, a bendable windscreen wiper lip is attached to one side of the lower part which is turned away from the upper part. A particularly high functionality of the windscreen wiper device is thereby advantageously produced.

According to a further embodiment, the lower part is connected to a tension-generating device to produce a tensile force acting on the lower part, particularly in the direction of the longitudinal extent of the lower part. Through this embodiment, the windscreen wiper device, in particular the lower part thereof, can be applied and adjusted to the curvature of the windscreen particularly accurately. The tensile force in this case is particularly transmitted by means of the connecting elements to the upper part. The tension-generating device may, for example, be realized by means of an actuator for producing length contractions. Said actuator is arranged in such a manner that the length contractions act on the lower part.

According to a further embodiment, the upper part is connected to a pressure-generating device for producing a compressive force acting on the upper part, particularly in the direction of the longitudinal extent of the upper part. This likewise allows a particularly accurate application and adjustment of the windscreen wiper device to the curvature of the windscreen. The compressive force is thereby particularly transmitted to the lower part by means of the connecting elements. The force-generating device may, for example, be realized by means of an actuator for producing length extractions which is arranged such that the length extractions act on the upper part.

According to a further embodiment, a plurality of actuators for producing length contractions and length extractions are present, said actuators being arranged in the lower part along the longitudinal extent thereof. This allows a particularly accurate application of the lower part right onto windscreens which exhibit a difficult curvature, i.e. in particular windscreens with convex and concave curvature components. The actuators are advantageously configured such that they contract in a region of the windscreen with a convex curvature and extract in a region of the windscreen with a concave curvature. The actuators may, in particular, be triggered by a control means by way of suitable electrical signals. For this purpose, it is advantageously possible for the windscreen to be wiped to be measured beforehand, in order to determine convex and concave curvature points. A model of the measured windscreen can then be stored in the control means. Alternatively or in addition, it is possible for one or a plurality of sensors to be provided with which the curvature of the windscreen can be determined. The information supplied by the sensors can be used for suitable triggering signals for the actuators.

According to a further embodiment, a gap is formed between the upper part and the lower part, in which a spoiler is arranged to influence an air flow penetrating the gap. In this way, the accurate wiping of the windscreen can advantageously be further improved. For example, the spoiler may be configured in such a way that particularly when the vehicle is travelling at high speeds, there is a balancing of a wind-lifting force that otherwise reduces the contact pressure of the windscreen wiper device on the windscreen. The spoiler may, in addition, be configured such that a wind lift is used to press the windscreen wiper device downwards in the direction of the windscreen. The contact pressure of the windscreen wiper device is increased and its particularly accurate application to the curvature of the windscreen guaranteed.

According to a further embodiment, at least a bendably configured part of the lower part is formed by means of a material that has a modulus of elasticity falling within a range between 0.005 kN/mm2 and 0.5 kN/mm2, in particular 0.01 kN/mm2 and 0.1 kN/mm2. In this way, a particularly bendable and flexible lower part can be achieved.

According to a further embodiment, the windscreen wiper device according to the invention is of such a design that it is constructed according to a so-called fin ray principle. This fin ray principle is derived from the structure of the fins of certain fish. According to the fin ray principle, the lower part of the windscreen wiper device, and advantageously the upper part thereof too, does not deviate in the direction of the compressive force when a compressive force occurs on the lower part, but arches in the opposite direction, i.e. in the direction from which the compressive force comes.

### BRIEF DESCRIPTION OF THE DRAWINGS

Exemplary embodiments of the invention are depicted in the figures and described in greater detail below. In the figures:

FIG. 1A shows a schematic representation of an exemplary embodiment of a windscreen wiper device according to the invention in the form of a wiper blade in an initial position,

FIG. 1B shows a schematic representation of the wiper blade according to FIG. 1A in a position applied to a windscreen,

FIG. 2A shows a schematic representation of a further exemplary embodiment of a windscreen wiper device according to the invention in the form of a wiper arm with an integrated wiper blade in an initial position,

FIG. 2B shows a schematic representation of the wiper arm with integrated wiper blade according to FIG. 2A in a position applied to a windscreen,

FIG. 3A shows a schematic representation of a detail of the wiper blade according to FIG. 2A,

FIG. 3B shows a schematic representation of a detail of the wiper blade according to FIG. 2B,

FIG. 4A shows a schematic representation of a further exemplary embodiment of a windscreen wiper device according to the invention in an initial position with an actuator as the tension-generating device,

FIG. 4B shows a schematic representation of the windscreen wiper device according to FIG. 4A in a position applied to a windscreen,

FIG. 5A shows a schematic representation of an exemplary embodiment of a windscreen wiper device according to the invention in an initial position with an actuator as the pressure-generating device,

FIG. 5B shows a schematic representation of the windscreen wiper device according to FIG. 5A in a position applied to a windscreen,

FIG. 6A shows a schematic representation of a further exemplary embodiment of a windscreen wiper device according to the invention in an initial position with an actuator as the tension-generating device and a further actuator as the pressure-generating device.

FIG. 6B shows a schematic representation of the windscreen wiper device according to FIG. 6A in a position applied to a windscreen.

FIG. 7A shows a schematic representation of an exemplary embodiment of a windscreen wiper device according to the invention in an initial position with a plurality of actuators as tension-generating and pressure-generating devices and

FIG. 7B shows a schematic representation of the windscreen wiper device according to FIG. 7A in a position applied to a windscreen.

FIG. 8A shows a schematic representation of a further exemplary embodiment of a windscreen wiper device according to the invention with an integrated spoiler and

FIG. 8B shows a schematic representation of a cross section through the windscreen wiper device according to FIG. 8A.

### DETAILED DESCRIPTION

Unless otherwise indicated, the same reference numbers are used below for identical elements and those having the same effect.

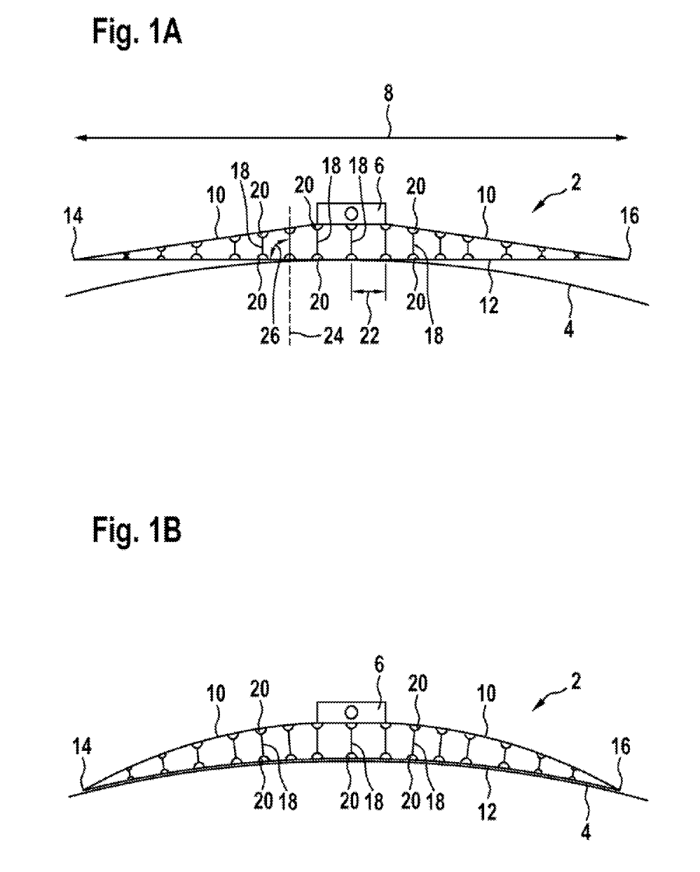

FIG. 1 shows a schematic representation of an exemplary embodiment of a windscreen wiper device according to the invention. The windscreen wiper device in this exemplary embodiment is a wiper blade 2. The wiper blade 2 is used to wipe a windscreen 4 of a vehicle, in this case a motor vehicle, in particular a car. The wiper blade 2 is usually attached to a wiper arm which is driven by means of a motor for wiping. For this purpose, the wiper blade 2 exhibits a mount 6 at which it can be fastened to the wiper arm. The wiper blade 2 in FIG. 1 is located in an initial position in which it is raised at least partially from the windscreen 4. The wiper blade 2 has a longitudinal extent 8 and exhibits an elongate upper part 10 and a likewise elongate lower part 12. The longitudinal extents of the upper part 10 and the lower part 12 largely correspond to the longitudinal extent 8 of the wiper blade 2. Both the upper part 10 and also the lower part 12 are bendable beams which are each of one-piece design in this case. This allows a particularly stable construction. It is likewise possible for only one part of the upper part 10 and/or of the lower part 12 to be of bendable design. In addition, it is alternatively possible for the upper part 8 to be of two-piece design, wherein one end of the two parts of the two-piece upper part 8 in each case are fastened to the mount 6. In order to achieve suitable bendability of the upper part 10 and of the lower part 12, a material is used for these parts 10, 12 that has a modulus of elasticity falling within a range between 0.005 kN/mm2 and 0.5 kN/mm2, in particular 0.01 kN/mm2 and 0.1 kN/mm2. Along with a suitably configured cross-sectional surface of the upper part 10 and of the lower part 12, optimum bending stiffness is thereby achieved. The upper part 10 and the lower part 12 are arranged such that they lie opposite one another. Both ends of the upper part 10 are each fixedly connected to an end of the lower part 12 at outer connection positions 14 and 16. Otherwise, the upper part 10 and the lower part 12 are spaced apart from one another.

The upper part 10 and the lower part 12 are connected to one another by connecting elements 18. Particularly in the initial position of the wiper blade 2, said connecting elements run approximately transversely to the longitudinal extent 8 of the wiper blade 2. The connecting elements 18 are fastened to inner longitudinal sides of the upper part 10 and of the lower part 12, said sides facing one another, by means of rotary joints 20. The rotary joints 20 are hinges in this case. In particular, the rotary joints 20 may be configured as integral hinges. This is particularly advantageous when the upper part 10, lower part 12 and/or connecting elements 18 are produced from a plastics material or covered with a suitable plastics material.

According to typical embodiments described here which can be combined with other embodiments described here, a rotary joint is selected from the following group comprising: a hinge, an integral hinge, a tapering of the material to produce reduced stiffness along a torsional axis, a joint with a rotational axis, a means for connecting the upper part to the connecting element or for connecting the lower part to the connecting element which allows displacement of the lower part in respect of the upper part along the longitudinal extent, etc.

The connecting elements 18 are spaced apart from one another along the longitudinal extent of the wiper blade 2. The spaces between two adjacent connecting elements 18 are identical in each case. However, different ones may also be chosen. The spaces are advantageously smaller than 50 mm, in particular smaller than 30 mm. In the present exemplary embodiment, a space 22 is depicted to replace the spaces between two connecting elements 18 in each case. The connecting elements 18 are, particularly in the initial position of the wiper blade 2, fastened to the lower part 12 such that their longitudinal axes run at angles to the lower part 12 which fall between 65° and 115°, in particular between 75° and 105°. Particularly advantageously, the angles fall between 80° and 100°. The same applies in the present exemplary embodiment to fastenings of the connecting elements 18 to the upper part 10. In FIG. 1A a longitudinal axis 24 is depicted by way of example for the longitudinal axes of the connecting elements 18 and an angle 26 is depicted by way of example for the angles between the connecting elements 18 and the lower part 12. The spaces between the upper part 10 and the lower part 12 are primarily determined by the lengths of the connecting elements 18. The lengths of the connecting elements 18 increase, starting from the two outer connection positions 14, 16, roughly up to those points at which the mount 6 attached to the upper part 10 begins. In this way, the upper part 10 and the lower part 12 in the side view of the wiper blade 2 according to FIG. 1A form a double wedge, wherein the tips of the two wedges point in opposite directions. The connecting elements are of kink-resistant design.

FIG. 1B shows a schematic representation of the wiper blade 2 according to FIG. 1A in a position applied to the windscreen 4. Since the windscreen 4 has a curvature, contact compressive forces act on the lower part 12 when the wiper blade 2 is applied to the windscreen 4. Since the upper part 10 and the lower part 12 are bendable beams and the connecting elements 12 are mounted rotatably on the upper part 10 and the lower part 12, the upper part 10 and the lower part 12 are displaceable in respect of one another. Due to the compressive forces acting on the lower part 12 from below, the wiper blade 2 bends in the direction from which the compressive forces come and is applied right to the curvature of the windscreen 4. In the representation according to FIG. 1B there is a small space between the wiper blade 2 and the windscreen 4 which is only used in this case to illustrate the windscreen 4 and the wiper blade 2 and in reality is largely not present in this way when the wiper blade 2 is applied to the windscreen 4. Furthermore, on the underside of the lower part 12 facing away from the upper part 10 is located a rubber lip which, in the interests of clarity, is not represented and which sits on the windscreen 4 for wiping purposes.

A windscreen wiper device of this kind, for example a wiper arm or a wiper arm with a wiper blade, has the advantage of an improved adjustment to a motor vehicle windscreen. With a traditional wiper blade, the upper part thereof is usually rigid, i.e. it is not of bendable design.

A windscreen wiper device according to the embodiments described here uses the effect of the tail fins of certain fish which are not deflected in the pressure direction when there is lateral pressure but instead arch in the opposite direction, i.e. in the direction from which the pressure comes. This principle is also referred to as the fin ray principle.

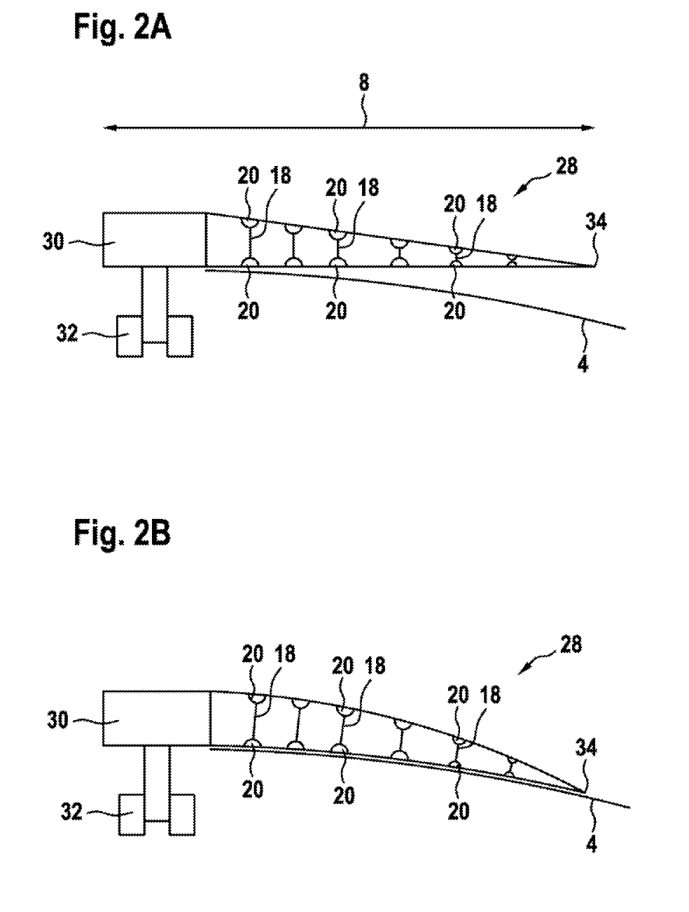

FIG. 2A shows a schematic representation of a further exemplary embodiment of the windscreen wiper device according to the invention in the initial position. The windscreen wiper device in this case is a wiper arm with an integrated wiper blade 28 which is attached to a fastening part 30. The fastening part 30 is connected to a wiper motor 32 which drives the fastening part 30 to wipe the windscreen 4. The wiper blade 28 is of wedge-shaped design, wherein one end of the upper part 10 is fixedly connected at an outer connection position 34 to one end of the lower part 12. The other ends of the upper part 10 and the lower part 12 in each case are fastened to the fastening part 30. In relation to the underlying design and, in particular, the fastenings of the connecting elements 18, the windscreen wiper device according to FIG. 2A corresponds in principle to that according to FIG. 1A.

FIG. 2B shows a schematic representation of the wiper blade 28 with an integrated wiper arm 30 according to FIG. 2A in a position applied to the windscreen 4. Here, too, compressive forces act on the lower part 12 of the wiper blade 28 from below from the direction of the windscreen 4, so that the lower part 12 and the upper part 10 bend in the direction of the windscreen 4.

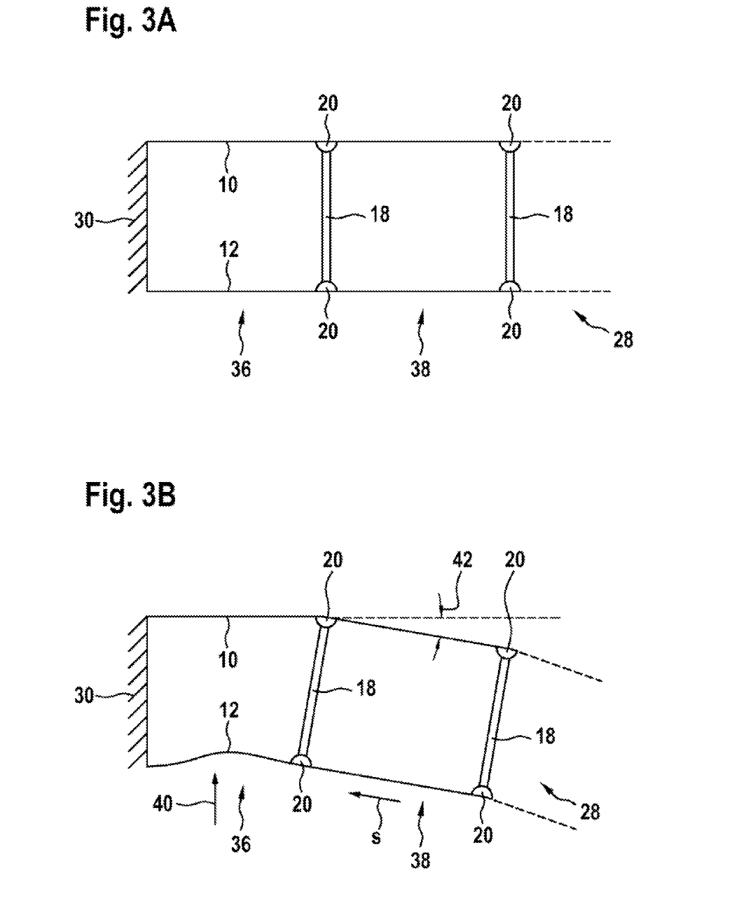

FIG. 3A shows a schematic representation of a detail of the wiper blade 28 according to the exemplary embodiment in FIG. 2A, in which the wiper blade 28 is located in the initial position. Depicted is the left end region of the wiper blade 28, in which one end of the upper part 10 and one end of the lower part 12 are fastened to the fastening part 30. Starting from the transition from the fastening part 30 to the wiper blade 28, FIG. 3A shows the first two connecting elements 18 delimit the two wiper blade elements 36 and 38. The connecting elements 18 are fastened via rotary joints 20 to the upper part 10 and the lower part 12.

FIG. 3B shows a schematic representation of a detail of the wiper blade 28 according to the exemplary embodiment in FIG. 2B, in which the wiper blade 28 is applied to the windscreen 4. Compressive forces act on the lower part 12 from below from the direction of the windscreen. A compressive force 40 is depicted in FIG. 3B representing the compressive forces. The compressive force 40 causes an arching and bending of the lower part 12 of the wiper blade element 36. In this way, the rotary joint 20 of the first connecting element 18 is displaced to the left about a path s. The second wiper blade element 38 is bent downwards in the direction from which the compressive force 40 comes and molds to the windscreen. This produces an angle 42 between the first wiper blade element 36 and the second wiper blade element 38. In addition, a further compressive force is created which then acts on the lower part 12 of the second wiper blade element 38 and prevents a further downward bending of the second wiper blade element 38. A chain reaction occurs at the right adjacent wiper blade element to the end of the wiper blade 28.

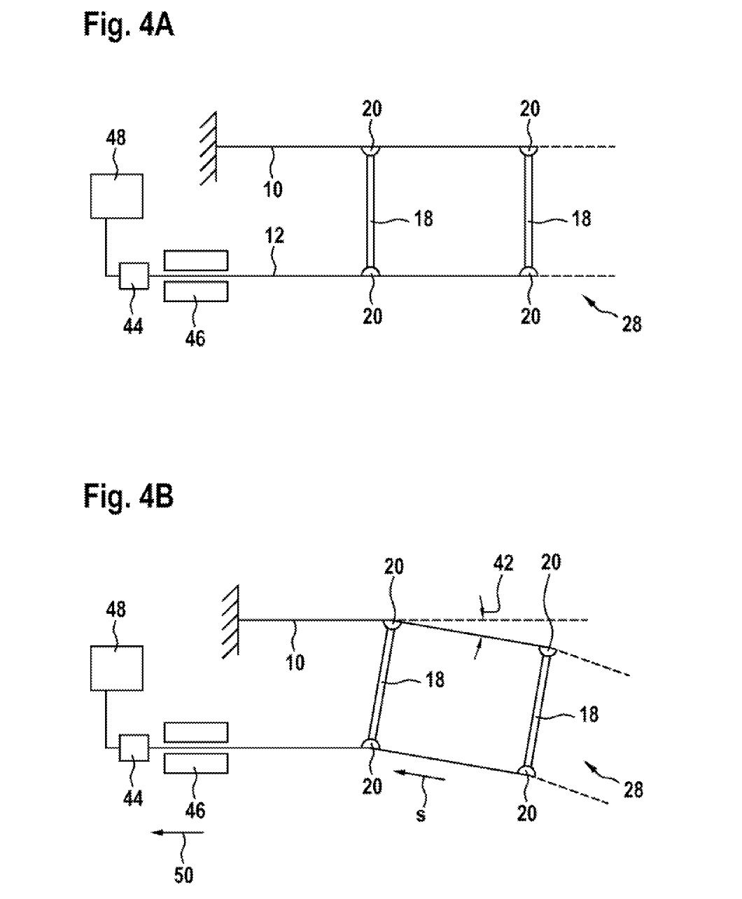

FIG. 4A shows a schematic representation of a further exemplary embodiment of the windscreen wiper device in an initial position with an actuator 44 as the tension-generating device. The actuator 44 is connected to the left end of the lower part 12 which is conducted in its end region through a guide 46. The actuator 44 is a piezo actuator which can perform length contractions. For this purpose, it is connected to a control unit 48 which triggers the actuator 44 by means of a suitable electrical signal. The control means 48 is configured such that it determines suitable triggering signals for the actuator 44 based on the curvature of the windscreen. With this kind of contraction, a tensile force 50 is exerted on the lower part 12 in the longitudinal extent 8 of the windscreen wiper device. That is depicted in FIG. 4B. The same chain reaction is carried out in principle by the tensile force 50 which has already been described above in connection with FIG. 3B.

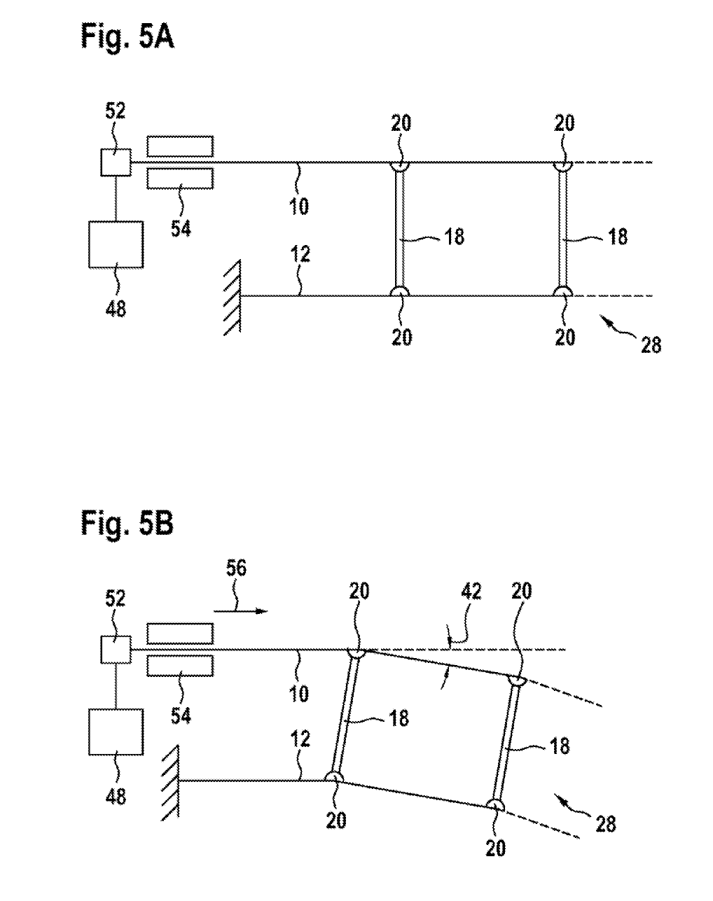

FIG. 5A shows a schematic representation of an exemplary embodiment of the windscreen wiper device according to the invention in an initial position with an actuator 52 as the pressure-generating device. The actuator 52 is connected to the left end of the upper part 10 which is guided in its end region by a guide 54. The actuator 52 can perform length extractions. For this purpose, it is connected to the control unit 48 which triggers the actuator 52 by means of a suitable electrical signal. During an extraction of the actuator 52, a compressive force 56 is exerted on the upper part 10 in the longitudinal extent 8 of the windscreen wiper device. This is depicted in FIG. 5B. Through the compressive force 50, the upper part 10 and the lower part 12 are bent downwards in the direction of the windscreen. The compressive force 50 is transmitted to the lower part 12 via the connecting elements 18. The same chain reaction in principle is carried out as has already been described above in conjunction with FIG. 3B.

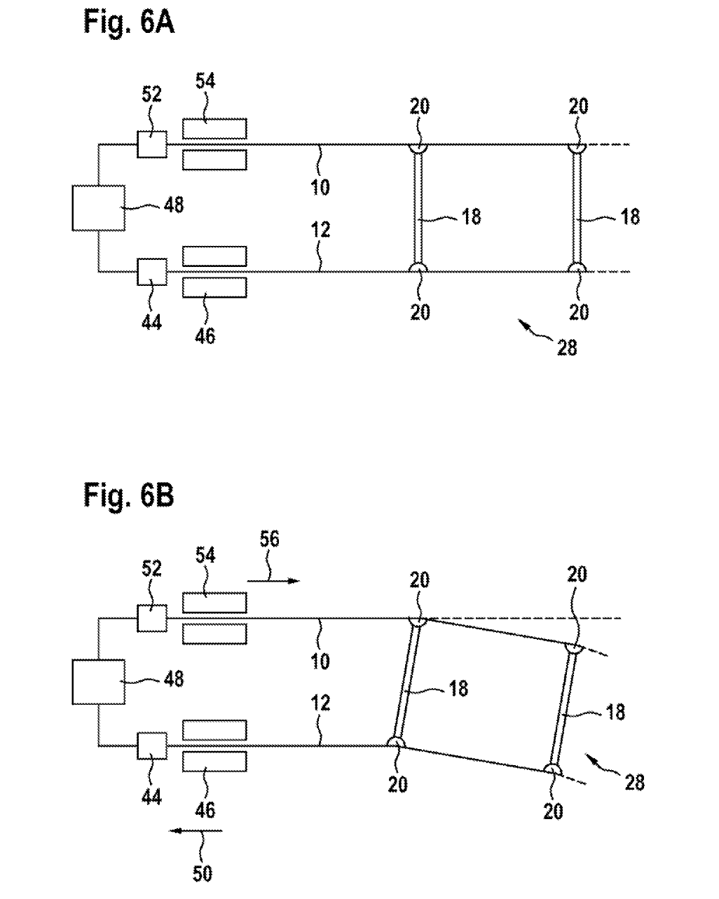

FIGS. 6A and 6B show schematic representations of an exemplary embodiment of the windscreen wiper device with the actuator 44 as the tension-generating device and the actuator 50 as the pressure-generating device. This exemplary embodiment represents a combination of the two exemplary embodiments according to FIGS. 4A, B and FIGS. 5A, B.

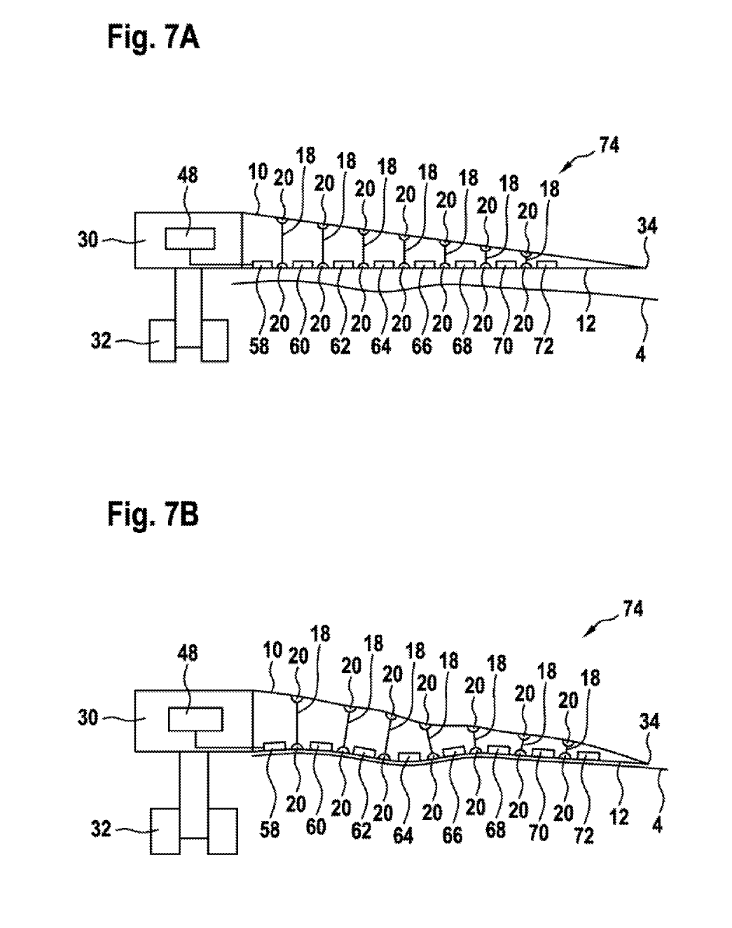

FIGS. 7A, B show schematic representations of an exemplary embodiment of the windscreen wiper device according to the invention with a plurality of actuators 58 to 72 as tension-generating and pressure-generating devices. FIG. 7A shows the windscreen wiper device in the initial position and FIG. 7B in the position applied to the windscreen 4. The windscreen wiper device contains a wiper blade 74 which is connected to the fastening part 30. The actuators 58-72 are arranged in the lower part 12 along the longitudinal extent thereof and can perform length contractions or length extractions. For this purpose, they are connected to the control unit 48 which supplies the actuators 58-72 with suitable triggering signals. In FIGS. 7A, B only one connection from the control unit 48 to the first actuator 58 is depicted by way of example in each case, for reasons of clarity. The first actuator is disposed between the fastening part 30 and the first connecting element 18 and the last actuator 72 between the last connecting element 18 and the end of the wiper blade 74, i.e. the outer connection position 34. The other actuators 60-70 are located between adjacent connecting elements 18. In this way, an actuator 58-72 is arranged in the lower part 12 of each element or partial region of the wiper blade 74. In this case, the windscreen 4 occasionally has strong concave and convex curvature components. In a convex curvature region, the actuators 58-72 contract and in a concave curvature region the actuators 58-72 extract. In the exemplary embodiment according to FIG. 7B, the actuator 64 has extracted while the remaining actuators 58-62, 66-72 have contracted.

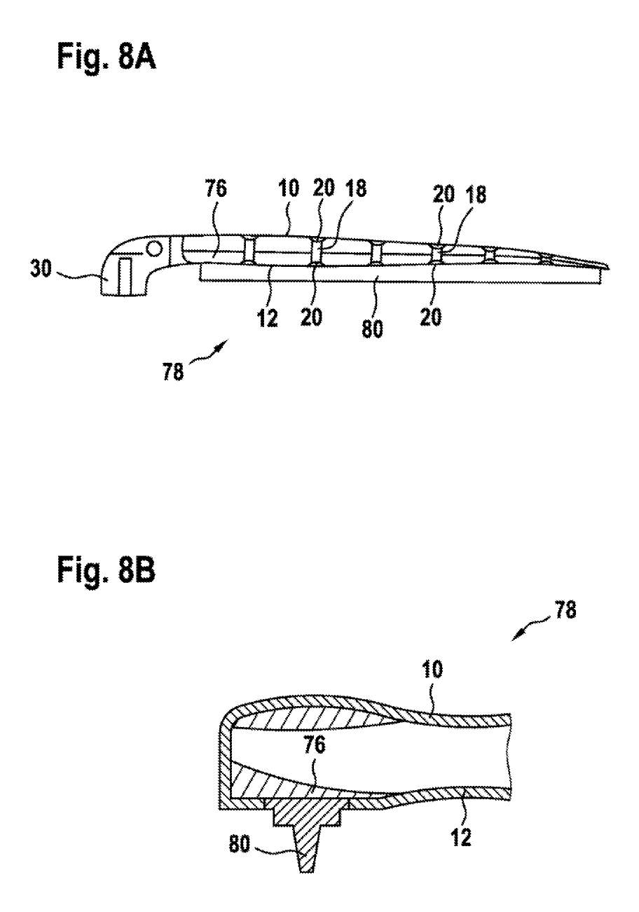

FIG. 8A shows a schematic representation of an exemplary embodiment of the windscreen wiper device according to the invention with an integrated spoiler 76. The windscreen wiper device exhibits a wiper blade 78, to the lower part 12 whereof a rubber lip 80 is attached to wipe the windscreen. The spoiler 76 is integrated in a gap 82 configured between the upper part 10 and the lower part 12. The spoiler 76 is used to influence an air flow penetrating the gap 82. The spoiler 76 is realized as an incline which is configured on the lower part 12 of the wiper blade 78. The spoiler 76 may be produced from rubber, for example, which is injected about a suitable wiper blade structure, e.g. made of steel.

FIG. 8B shows a schematic representation of a cross section through the wiper blade 78 according to FIG. 8A.

1. A windscreen wiper device (2; 28; 30; 74; 78) for a vehicle, comprising
an elongate upper part (10) which is at least partially bendable,
an elongate lower part (12) which is at least partially bendable, and
a plurality of connecting elements (18) connecting the upper part (10) and the lower part (12), wherein the connecting elements (18) are spaced apart from one another along a longitudinal extent (8) of the windscreen wiper device (2; 28; 30; 74; 78) and fastened to the lower part (12) by rotary joints (20).

2. The windscreen wiper device as claimed in claim 1, characterized in that the upper part (10) and the lower part (12), are fixedly connected to one another at an outer connection position (14; 16; 34), wherein the outer connection position (14; 16; 34) is configured in front of the connecting elements (18).

3. The windscreen wiper device as claimed in claim 1, characterized in that longitudinal axes (24) of the connecting elements (18) run at angles (26) to the lower part (12) of between 65° and 115°.

4. The windscreen wiper device as claimed in claim 1, characterized in that a space (22) between every two adjacent connecting elements (18) is smaller than 50 mm.

5. The windscreen wiper device as claimed in claim 1, characterized in that the upper part (10) is of one-piece or two-piece design.

6. The windscreen wiper device as claimed in claim 1, characterized in that a bendable windscreen wiper lip (80) is attached to one side of the lower part (12) which is turned away from the upper part (10).

7. The windscreen wiper device as claimed in claim 1, characterized in that the lower part (12) is connected to a tension-generating device (44) to produce a tensile force (50) acting on the lower part (12).

8. The windscreen wiper device as claimed in claim 1, characterized in that the upper part (10) is connected to a pressure-generating device (52) for producing a compressive force (56) acting on the upper part (10).

9. The windscreen wiper device as claimed in claim 1, further comprising a plurality of actuators (58-72) configured to produce length contractions and length extractions, said actuators being arranged in the lower part (12) along a longitudinal extent thereof

10. The windscreen wiper device as claimed in claim 1, characterized in that a gap (82) is formed between the upper part (10) and the lower part (12), in which a spoiler (76) is arranged to influence an air flow penetrating the gap (82).

11. The windscreen wiper device as claimed in claim 1, characterized in that the upper part (10) and the lower part (12), in an end region of the windscreen wiper device (2; 28;
30; 74; 78), are fixedly connected to one another at an outer connection position (14; 16;
34), wherein the outer connection position (14; 16; 34), viewed in a longitudinal extent (8) of the windscreen wiper device (2; 28; 30; 74; 78) in an inward direction from outside, is configured in front of the connecting elements (18).

12. The windscreen wiper device as claimed in claim 1, characterized in that longitudinal axes (24) of the connecting elements (18) run at angles (26) to the lower part (12) of between 75° and 105°.

13. The windscreen wiper device as claimed in claim 1, characterized in that a space (22) between every two adjacent connecting elements (18) is smaller than 30 mm.

14. The windscreen wiper device as claimed in claim 1, characterized in that the lower part (12) is connected to a tension-generating device (44) to produce a tensile force (50) acting on the lower part (12) in a direction of a longitudinal extent of the lower part (12).

15. The windscreen wiper device as claimed in claim 1, characterized in that the upper part (10) is connected to a pressure-generating device (52) for producing a compressive force (56) acting on the upper part (10) in a direction of a longitudinal extent of the upper part (10).
